(19) United States
(12) Patent Application Publication
(10) Pub. No.: US 2011/0153502 A1
(43) Pub. Date: Jun. 23, 2011

(54) SYSTEMS, METHODS, AND APPARATUS FOR IDENTIFYING INFLUENTIAL INDIVIDUALS

(76) Inventor: James Jean-Claude, Washington, DC (US)

(21) Appl. No.: 12/821,929

(22) Filed: Jun. 23, 2010

Related U.S. Application Data
(60) Provisional application No. 61/219,890, filed on Jun. 24, 2009.

(51) Int. Cl. G06Q 20/00

(52) U.S. Cl. 705/66

(57) ABSTRACT

In some embodiments, a method includes adding at least one virtual token to an account associated with a user of a token server, upon initial association of the user with the token server. The token server can be configured to transfer virtual tokens to and from accounts associated with a plurality of users. The token server can be accessible by one or more electronic devices in communication with the token server via a network. At least one virtual token can be transferred from an account associated with a first user of the token server to an account associated with a second user of the token server based upon a request received from the first user of the token server via an electronic device. The transferred virtual token can be associated, for example, with a popularity rating of the user receiving the virtual token.

### CROSS-REFERENCE TO RELATED APPLICATIONS

This application claims priority to and the benefit of U.S. Provisional Patent Application Ser. No. 61/219,890, filed Jun. 24, 2009, entitled “Systems, Methods, and Apparatus for Identifying Influential Individuals,” the disclosure of which is incorporated herein by reference in its entirety.

### BACKGROUND

The invention relates generally to methods, systems and apparatus related to identification of influential individuals and relationships among individuals.

Newspaper advertising, mass mailing campaigns, television and radio ads have generally been used by advertisers and marketers to influence the tastes and trends of individuals. These advertising methods are expensive and attempt to cast wide nets in order to catch the select few potential customers some sponsors are trying to reach. As a result, financial and other resources are wasted because these methods are not well focused on those select few potential customers.

### SUMMARY

In some embodiments, a method includes adding at least one virtual token to an account associated with a user of a token server, upon initial association of the user with the token server. The token server is configured to transfer virtual tokens to and from accounts associated with a plurality of users. The token server can be accessible by one or more electronic devices in communication with the token server via a network. At least one virtual token is transferred from an account associated with a first user of the token server to an account associated with a second user of the token server based upon a request received from the first user of the token server via an electronic device. The transferred virtual token can be associated, for example, with a popularity rating of the user receiving the virtual token.

### BRIEF DESCRIPTION OF THE DRAWING

FIG. 1 is a system block diagram of a system for distributing tokens via a communications network, according to an embodiment.

FIG. 2 is a flowchart illustrating user access of a token server according to an embodiment.

FIG. 3 is a block diagram of a system for distributing tokens via a communications network according to another embodiment.

FIG. 4 is a flowchart illustrating a method according to an embodiment.

FIG. 5 is a flowchart illustrating a method according to another embodiment.

### DETAILED DESCRIPTION

Every clique or group of individuals has influential individuals sometimes referred to as alpha male(s) or queen bee(s). These individuals influence the tastes, trends, and/or actions of their peers. Some embodiments disclosed herein can be useful in identifying such influential individuals. For example, an application, service, widget, or other interface can be provided within a social network application such as Facebook™, MySpace™, Bebo™, or as some other application in communication with a network. In some embodiments, influential or popular individuals can be nominated (e.g., via tokens or votes) for member status on the site by friends who think they are cool. Those who reach a required number of nominations can become eligible for free gifts and invitations to exclusive events courtesy of the service and its sponsors or partners (e.g., companies, advertisers, and/or marketers). Individuals can be incentivized to join the service or be active in the service (e.g., an online community) by way of free products and services from sponsors and marketing partners when these individuals reach the requisite number of nominations.

Individuals can join or subscribe to the service (application, widget, or other interface) and receive a finite number of tokens or votes (also referred to as “cool coins” or “virtual tokens”) that can be distributed via the service to other members or subscribers of the service. Cool coins can be the currency that members give to those they identify as influential, special, or cool. In one embodiment, each member receives one hundred cool coins to trade or distribute to other members of the service upon subscription to the service. For example, an application, widget, or other interface to the service can be provided within one or more social networks (e.g., a webpage providing an interface into a social network such as a user profile webpage), and members can distribute and/or receive cool coins via the application, widget, or other interface. In other words, a member can have a single subscription or account to the service with a single user profile and access the service from more than one website, social network, or other community. In some embodiments, a subscription to the service can be associated with or related to a single website, social network, or other community (e.g., an online community). Thus, in some embodiments, a member can have multiple access capabilities to the service (e.g., a subscription at one or more of the websites, social network, or other community). In some embodiments, the service can be provided via a single website, social network, or other community. Said differently, the service can be exclusive to a website, social network, or other community such that cool coins or other tokens are distributed exclusively to and from members of that website, social network, or other community. Thus, a user can have multiple social network identities associated with a single user account and profile for the service.

A threshold of cool coins such as, for example, ten cool coins can be set to define an influential individual. In some embodiments, influential individuals can be referred as “cool.” In other words, a member is categorized or described within the service as cool (or an influential individual) after that member receives ten cool coins from other members of the service. In some embodiments, other thresholds such as, for example, a greater or smaller quantity of cool coins or a rate of receipt of cool coins can be used to describe or flag a member as cool or influential.

After a member has been categorized as cool, that member can be provided with free gifts such as products and/or services and invitations to exclusive events from sponsors and partners. The member can then tell other individuals (e.g., friends and acquaintances) about the product, service, and/or event, which generates interest and demand for desirable products, services, and/or events. In other words, the member can influence other individuals to purchase or pay for the products, services, and/or events provided to the member for free.

In some embodiments, rules or limitations can be imposed upon the trade or distribution of cool coins. For example, each cool coin can only be given or taken away once per month; a limit can be placed on the quantity of cool coins any member can possess; the quantity of cool coins any member can possess can be unlimited; a quantity of cool coins a member can distribute can be limited and a quantity of cool coins that member can possess (e.g., receive from other members) can be unlimited; any member can only give one cool coin to any other member; any member can repossess (e.g., rescind or take back) a cool coin that that member gave to another member; and/or cool coins can be automatically returned to the member that originally held those cool coins (i.e., the member that received the cool coins upon subscription to the service) at some interval such as a yearly interval. In some embodiments, cool coins can include tracking information such that interaction between members can be observed. For example, to observe which member gives coins to other members to identify social cliques or networks, and monitor activity. For example, each cool coin can have a unique identifier that can be tracked and monitored as it is transferred from one account to another. In some embodiments, cool coins can include time and date stamps to allow monitoring of trading activity. Members can be limited to a single account or subscription to limit cool coin abuse. For example, having a single user account can prevent members from giving cool coins from one account held by that member to another account also held by that member in order to artificially inflate that member's own number of cool coins.

In addition, many known rating systems, regardless of the methodology used or purpose of the rating system, allow for manipulation of data by a user by repeat usage of the system via multiple visits to the website or multiple recorded votes using one or multiple profiles and computers. The service or token system described herein can include a serial number system that assigns a unique value or serial number to each cool coin, which can help limit fraud and data manipulation. Thus, the token system described herein can provide a security feature not available in other rating systems. For example, the token system can limit the number of cool coins that can be given to a recipient from another user/member. The limit can be, for example, one cool coin.

A vote or rating of approval by an individual can signify their opinion or feelings in regard to the person/product/trend/thing at “that moment in time.” Many known rating systems can only offer a “snapshot” of the sentiment/opinion one has and wishes to convey. In the token system described herein, allocation of a cool coin or token to an individual person/product/thing can reflect not only their favorable opinion of that object/person at that moment, but in perpetuity and in “real-time” up until, for example, the token giver retracts that token from the recipient. This can provide an accurate measure, and reflect the true dynamics of opinions and how they can change over time. Interpersonal relationships are dynamic, and the giving of a cool coin can measure and reflect that dynamic nature by providing the widget tools for members/users to reward/identify the behavior/products/persons/trends they find “cool” or desirable or admirable at a given time. The revocation of a token previously given to another can be meant to signify a lack of desire or respect for a product/person/thing that a user no longer finds to be “cool”. The scarcity and limiting of the number of tokens available for distribution also forces the users to self-identify and rank those products/persons/things they deem to be cool or important. In another example, the non-issuance of a cool coin or token by a member/user when requested by another user/member can signify their neutral or negative feelings/opinions toward that person/product/thing, or that the person may not rise to the high-level of opinion or favorability necessary for the rewarding/allocation of a token or cool coin.

In some embodiments, bonus cool coins (e.g., in addition to the quantity provided during subscription or membership creation within the service) can be given by a company, advertiser, or marketer to a member to encourage certain behavior or promote certain products. Additionally, incentive programs to earn bonus cool coins can add to a member's total. Bonus cool coins can be given for taking surveys, participating in focus groups, spending a certain amount of time on a website or within a social network, attending certain events, or purchasing select products from sponsors, etc.

In some embodiments, multiple classes of cool coins can exist. For example, gold coins can be the original or initial cool coins that all members receive when joining the service. Purple cool coins can be provided to known influential individuals, for example, celebrities and company executives to distribute to those they deem or consider cool or influential. In some embodiments, one purple cool coin can be equivalent in value to ten gold cool coins. Red cool coins can be company-, advertiser-, or marketer- (can also be referred to collectively as “partners”) issued cool coins to give to members for specific promotions or rewards. In some embodiments, red cool coins can be, for example, equivalent in value to five gold cool coins.

The service (also referred to as a marketing tool) can help marketers identify social leaders of a variety of demographics or cliques. This marketing tool can identify the social leaders (or influential individuals), and a website (or widget or application within or related to a social network) can be a database of these individuals. Marketers who want their products to be considered cool or trendy can pay for access to these trendsetters (e.g., become sponsors or partners of the service). Because marketers can directly identify and interact with influential individuals (or trendsetters), marketing efforts and resources can be efficiently allocated to influence the behavior of key influential individuals. For example, the service can monitor and track the transfer of cool coins between members and determine if a member has met a predetermined basis for being identified as cool or influential. This information can be made available to other members and/or third parties, such as marketers.

The service can generate income by connecting, and managing the relationships between influential or cool members and other members. Cool members can be provided with free passes to movie premieres (e.g., a cool member can see a movie before it is publicly released and be allowed to discuss the movie with friends to generate interest in the movie), free listening parties for recording artists who wish to promote their music, free products, etc. for their participation in the service. These members can function as a mass focus group for sponsors and partners who provide the free products for the members' consideration. The marketers can benefit when the members consider their products to be cool and discuss these products to create demand (or “generate buzz”) for the products amongst their peers. The advance buzz or demand will generate sales or grassroots support for their products, films, music, services, and/or other marketed items.

A member can receive gifts and/or other rewards for participating in various events, such as, surveys, focus groups, or for example, using a particular product. A sponsor of such events can receive information about users of the token server to help identify a target individual or group for a promotional activity. The target user can receive notification that there is a survey from a sponsor along with information about the gifts and rules associated with the promotion. The notification can also contain a link to a survey webpage. In addition, a user can be provided with a list of surveys to which he/she has been invited to participate. For example, the list can include information such as the name of the sponsor, the time period for filling out the survey, the name of the survey, and/or a link to the survey page. A survey can provide for users to receive a promotional gift for participating, or winners can be determined based on certain criteria. Notification that a user is found eligible for a promotional gift can be announced through several channels, for example, promotional banners on the token server website, notifications via email, newsletters, etc.

Similar to celebrities who receive free clothing from designers or gift bags at awards shows for promotional purposes, everyday, but popular (e.g., influential or cool), regular citizens will receive star treatment, just for being themselves, and for using the products they are given. In return, sponsors and partners receive a “viral” form of marketing unlike any other. For example, significant demand can be created for a product in a school in response to the most popular student receiving and using the latest MP3 player, cellular phone, or other product for free. Envy, jealousy, admiration, imitation and an effort to “keep up with the Joneses” will persuade many of the student's classmates to purchase similar products. This grassroots-level marketing method and related systems and apparatus is the basis for a unique form of advertising.

In some embodiments, sponsors and partners can pay a fee for access to influential members of the service. For example, to receive data associated with the transfer of cool coins between members as described previously. Additionally, websites related to the service can sell advertising space including, for example, click-through or pay-per-click advertisements. In some embodiments, sponsors and partners can have discounted or free advertising space on such websites. Furthermore, access to data related to the interactions among members (e.g., information related to which members are giving or repossessing cool coins from which other members) can be marketed or sold for market data collection and analysis, and event promotion.

In the following example, a company wants to reach certain people in a community of 10,000. Instead of taking on expensive options, such as a full page ad in the local newspaper, or buying a television commercial, this service can offer a cost effective marketing campaign that targets 500 or 1,000 of the most socially influential people in that community of 10,000 and let their approval of a product and word-of-mouth promotion of the product create a trend or grassroots support for that product. Because cool coins are currency unique to the service, cool coins can help marketers identify the most popular members of various websites, social networks, and communities (both online and offline). By identifying influential individuals, the service helps marketers save significant amounts of wasted dollars lost in traditional methods of advertising by more accurately targeting the audiences they are trying to reach.

Additionally, the website can help marketers identify social leaders of, or within, a variety of demographics or cliques. By identifying those social leaders, marketers can directly reach out to them to influence their peers into using a sponsor's products or services. Because marketers directly influence the individuals who influence groups, this sort of marketing can be, for example, more efficient than other marketing or advertising methods.

Furthermore, the website can identify (or aid in identification of) the various roles of one or more individuals within different cliques. For example, an individual can be a social leader within a first clique (or group of cliques), and not be a social leader in a second clique (or group of cliques). By tracking the flow of cool coins between members, it can be possible to determine that an individual receives many cool coins from members of the first clique (and is therefore deemed a social leader within the first clique), and receives few, if any, cool coins from members of the second clique (and is therefore not deemed a social leader within the second clique). Thus, the role(s) of an individual in multiple cliques or other social groups can be determined and/or monitored as the role(s) in the cliques change over time.

The service can provide sponsors, partners, and/or other companies or individuals with various advertising methodologies including: pay-per-click advertising; direct product promotion (e.g., distributing products to cool members); pay-per-impressions advertising (e.g., pay per 1,000 views); a “Cool Products Corner” such as an online shopping room, website, or webpage including trendy products selected by the service, sponsors or partners, and members are sold, and a commission can be collected for each product sold in the room; “Cool Correspondence” such as a weekly email from the service to all members featuring website news and articles of interest on the latest trends and fashion and including advertisements and links to services or products; pop-up ads; focus group organization in which participants are recruited based on, for example, the number of cool coins held by those members; market data collection and analysis (e.g., which individuals or classes of individuals are cool and which products or services interest these individuals; event promotion; music and movie promotion; and charity fundraising and/or awareness. In some embodiments, web search engines can be partners, these search engines can pay a fee for each member that is directed to the search engine. In some embodiments, the service can include a “Cool Content Section” such as an online chat room, website, or webpage featuring articles and news related to fashion and trends, social gossip, and/or news. This section can encourage members to visit a social network, website, or other online application more often and to stay on longer. Banner advertising and promotional links paid for by sponsors and partners can be included in this room as well.

The cool coins service (also referred to as a widget, system, and/or website) can accurately measure in real-time the popularity of consumer products, people, friendships, and works of art (music, film, visual, audio, literary, etc). This measurement system is accurate in real-time because members have only a finite number of cool coins that can be distributed, and these cool coins can be repossessed or revoked if a members' impression of another individual changes. What is cool or popular now can change quickly, and often; this service accounts for those changes. For example, by limiting the number of cool coins a member can give away, a finite resource is created that has no real purchasing power but real influence in a promotions and rewards system, on the development of products, and the marketing of products, brands, and/or people. In some embodiments, members do not receive additional cool coins to give away in addition to the number they start with, therefore they will be forced to be selective in whom or what they reward with these cool coins. If a member has distributed all the cool coins they were originally allocated when they created their account with the service, and then encounter another product or member they would like to reward with a cool coin; that member can repossess or reclaim a cool coin from a previous recipient and give that cool coin to another member. Generally, the cool coin will be reclaimed from a member that the repossessing member does not consider as cool or desirable as the new recipient member. The limited number coin allotment compels members to rank all their friends, music, films, consumer products, etc.; and to be selective as to whom they reward with cool coins. Thus, the cool coins service empowers the members of the service to decide who gets rewarded and under what criteria. In other words, the actions of the members (e.g., distribution of cool coins) defines what people, products, works of art, etc. are cool at any given time, and which should be rewarded.

The cool coins service can also be used to identify relationships among users, for example, based on the social theory of “Six Degrees of Separation.” In some embodiments, the service includes a “Pal Pyramid” system. Each new member can be the head or point of a new “Pal Pyramid,” and/or the brick in another member's Pal Pyramid. For example, new member A joins the program and becomes the head of Pal Pyramid “A”. That member then builds up the Pal Pyramids of others by distributing coins, for example, to friends and family, etc; and grows his own by receiving coins from friends and family, etc. In other words, that member becomes a brick in the pyramids of every friend he gives a coin to, and the friends whom give member “A” a coin become a brick in Pal Pyramid “A”. By correlating bricks (e.g., relationships) of the Pal Pyramids, social groups can be identified and information about social groups such as who knows who via the “six degrees of separation” principles can be determined, for example. In some embodiments, members with taller (or bigger) Pal Pyramids can receive greater rewards than shorter (or smaller) Pal Pyramids. In some embodiments, all qualified (e.g., having a requisite number of bricks or of a required size) Pal Pyramids can receive some type of reward.

Similarly, the service can be used to identify relationships among multiple groups or cliques. For example, a single member can receive cool coins from other members that are associated or affiliated with various different groups. Analysis of the flow of coins from these members to the single member can reveal that the single member is influential among the various groups. More specifically, for example, a member can be designated as cool within one group (e.g., people living in New York City) after that member receives 1,000 cool coins from members of that group, and can be designated as cool within another group (e.g., members of a particular profession) after that member receives 100 cool coins from members of that group. Furthermore, in some embodiments, a first group can be designated as influential to a second group if a predetermined number of members of the first group have been designated as influential within the second group.

In some embodiments, a group can receive cool coins from another group or another individual. For example, a particular club or association can have a subscription with the service with a group user profile. The group as a whole can receive benefits from being deemed cool or influential rather than the individual members of the group. In addition, artifacts, such as a video, a song, a book, products, etc. can receive cool coins. For example, a group or individual member, or third party can sponsor an artifact, and members of the service can transfer cool coins to that artifact to indicate that they find it cool or interesting.

In some embodiments, the numbers or quantities of coins can be given geographic or social weights or weighting multiples to determine whether a member is cool or qualified for some reward. Said differently, a determination that a member is cool or qualified for some reward can be based on criteria other than, or in addition to, the quantity of coins that member has received. For example, that a member in New York City has one hundred cool coins does not necessarily convey the same information about the influence or popularity of a member in Idaho with one hundred cool coins. The member in Idaho may have an equal coin total to that member in New York City, but the Idaho member is in the top 10% of his geographical peer group, whereas the New York City member is in the top 30% of his geographical peer group. Thus, the Idaho member can be deemed more influential than the New York City member and can be treated better or rewarded more than the New York City member.

In some embodiments, the service can be provided by a computer server operatively coupled to a network, and can be accessed by client devices such as personal computers, cellular devices, personal digital assistants, and/or other devices operatively coupled to the network and running web (or Internet) browsers or other applications. For example, the service can be provided by a web server accessible via the Internet and client devices (and members using the client devices) can access the service with web browsers running on the client devices via the Internet.

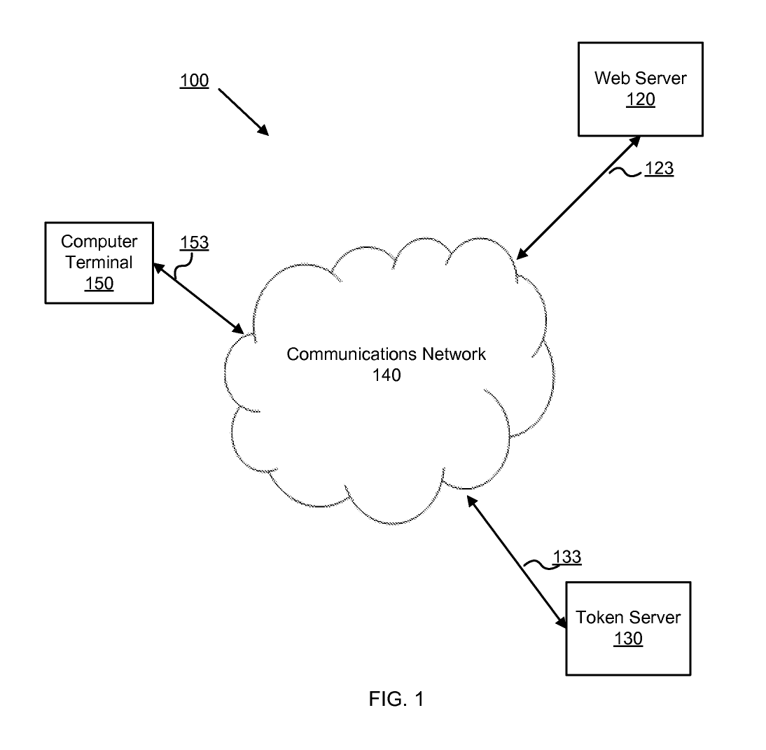

FIG. 1 is a system block diagram of system 100 for distributing tokens via a communications network, according to an embodiment. System 100 includes web server 120, token server 130, and computer terminal 150 operatively coupled to communications network 140. Computer terminal 150 can be any of a variety of communication devices that can be operatively coupled to communications network 140. For example, a computer terminal can be a personal computer, a laptop computer, a personal digital assistant (PDA), a cellular telephone, and/or some other communication device. Computer terminal 150 can include a web browser configured to access a webpage or website (such as a social network application or online community) hosted on or accessible via web server 120 over communications network 140. A webpage or website can be accessed by a user of a web browser at computer terminal 150 by providing the web browser with a reference such as a uniform resource locator (URL), for example, of a webpage. In some embodiments, computer terminal 150 can include specialized software for accessing web server 120 other than a browser such as, for example, a specialized network-enabled application or program. In some embodiments, portions of a website accessible via web server 120 can be located in a database (not shown) accessible to web server 120. Similarly, a database (not shown) including, for example, information related to quantities or exchanges of tokens can be accessible to token server 130.

Communications network 140 can be any communications network configurable to allow web server 120, token server 130 and computer terminal 150 to communicate with communications network 140 and/or to each other through communications network 140. In other words, communications network 140 can be any network or combination of networks capable of transmitting information (e.g., data and/or signals) including, for example, a telephone network, an Ethernet network, a fiber-optic network, a wireless network, and/or a cellular network.

In some embodiments, communications network 140 can include multiple networks operatively coupled one to another by, for example, network bridges, routers, switches and/or gateways. For example, computer terminal 150 can be operatively coupled to a cellular network, web server 120 can be operatively coupled to an Ethernet network, and token server 130 can be operatively coupled to a fiber-optic network. The cellular network, Ethernet network and fiber-optic network can each be operatively coupled one to another via one or more network bridges, routers, switches and/or gateways such that the cellular network, the Ethernet network and the fiber-optic network are operatively coupled to form collectively a communications network. Alternatively, for example, the cellular network, the Ethernet network and the fiber-optic network can each be operatively coupled to the Internet such that the cellular network, the Ethernet network, the fiber-optic network and the Internet are operatively coupled to form collectively a communications network.

As illustrated in FIG. 1, web server 120 is operatively coupled to communications network 140 via network connection 123; token server 130 is operatively coupled to communications network 140 via network connection 133; and computer terminal 150 is operatively coupled to communications network 140 via network connection 153. Network connections 123, 133 and 153 can be any appropriate network connection for operatively coupling web server 120, token server 130 and computer terminal 150, respectively, to communications network 140.

In some embodiments, a network connection can be a wireless network connection such as, for example, a wireless fidelity (Wi-Fi) or wireless local area network (WLAN) connection, a wireless wide area network (WWAN) connection, and/or a cellular connection. In some embodiments, a network connection can be a cable connection such as, for example, an Ethernet connection, a digital subscription line (DSL) connection, a broadband coaxial connection, and/or a fiber-optic connection. In some embodiments, a computer terminal, a web server and/or a token server can be operatively coupled to a communications network by heterogeneous network connections. For example, a computer terminal can be operatively coupled to the communications network by a WWAN network connection, a web server can be operatively coupled to the communications network by a DSL network connection, and a token server can be operatively coupled to the communications network by a fiber-optic network connection.

In some embodiments web server 120, token server 130, and/or computer terminal 150 includes (not shown) a processor, a network interface, and a memory. For example, web server 130 can be operatively coupled to communications network 140 via a network interface and network connection 133. The network interface can be any network interface configurable to be operatively coupled to communications network 140 via network connection 133. For example, a network interface can be a wireless interface such as, for example, a worldwide interoperability for microwave access (WiMAX) interface, a high-speed packet access (HSPA) interface, and/or a WLAN interface. A network interface can also be, for example, an Ethernet interface, a broadband interface, a fiber-optic interface, and/or a telephony interface.

In some embodiments, one or more of web server 120, token server 130, and/or computer terminal 150 can be a virtual device implemented in software such as, for example, a virtual machine executing on or in a processor. For example, a token server can be a software module executing in a virtual machine environment such as, for example, a Java™ module executing in a Java™ Virtual Machine (JVM), or an operating system executing in a VMware™ virtual machine. In some such embodiments, a network interface, a processor, and a memory can be virtualized and implemented in software executing in, or as part of, a virtual machine.

Web server 120 can provide access to a webpage including a widget or application configured to allow a user of computer terminal 150 to distribute tokens or cool coins. For example, an application can provide a list of members of a social network that are associated with the user of computer terminal 150, a balance of tokens the user of computer terminal 150 has that can be distributed, and a balance of tokens the user of computer terminal 150 has received from other members of the social network. In some embodiments, web server 120 can communicate with token server 130 via communications network 140 to determine the balance (or quantity) of tokens the user of computer terminal 150 has that can be distributed, and/or the balance (or quantity) of tokens the user of computer terminal 150 has received from other members of the social network. In other words, token server 130 can store and/or monitor balances and/or exchanges of tokens in response to communication from web server 120. In some embodiments, the widget or application can be hosted at token server 130 and displayed at a portion of a webpage or website hosted at web server 120.

The user of computer terminal 150 can select another member from the list of members and send (via computer terminal 150) one or more signals (e.g., one or more data packets) to web server 120 and/or token server 130 indicating that a number of tokens from the balance of tokens the user of computer terminal 150 has to distribute should be sent to the selected member. Web site 120 and/or token server 130 can receive the signal and distribute the tokens based on the signal (e.g., reduce the balance of tokens the user of computer terminal 150 has to distribute and increase the balance of tokens the selected member has received). In some embodiments, the signal is sent to web server 120 and web server 120 sends a portion of the signal (or another signal based on the signal sent from computer terminal 150) to token server 130. Token server 130 can then distribute the tokens. In some embodiments, the signal can be sent to token server 130, and token server 130 can distribute the tokens and provide an update signal to web server 120 including updated balances of tokens (e.g., a balance of tokens the user of computer terminal 150 has that can be distributed, a balance of tokens the user of computer terminal 150 has received from other members of the social network, and/or a balance of tokens the selected member has received from other members of the social network).

In some embodiments, web server 120 can include some or all of the functionality of token server 130. In other words, a web server can also be a token server. In some embodiments, multiple web servers can communicate with a single token server to access information related to balances (or quantities) and/or exchanges of tokens. In some embodiments, a single web server can communicate with multiple token servers to access information related to balances (or quantities) and/or exchanges of tokens. For example, information related to balances (or quantities) and/or exchanges of tokens of one member can be accessible at one token server and information related to balances (or quantities) and/or exchanges of tokens of another member can be accessible at another token server. In some embodiments, a system can include multiple web servers and multiple token servers that are distributed, for example, geographically to provide desirable performance (e.g., data transfer rates or access times) and/or redundancy.

To register or subscribe as a user of the token server 130, the user can access the token server using an electronic device in communication with the token server 130 through the network 140. The user can access the token server 130 via a social network webpage 150 or directly. The user then enters requested information to create a user profile. For example, the user may be asked to provide, his/her name, address, email address, etc., and to provide information regarding the user's interests. The information provided by the user is validated against a set of rules that relate to format and value constraints. The system can also validate whether the user name is unique and that there are no other potential matches for the provided information. This ensures that the user will have only one account with the service. After reviewing and accepting the terms of agreement for use of the system, the user verifies his/her email address to activate the account. A predefined quantity of cool coins (also referred to as “tokens” or “virtual tokens”) can then be added to the user's account. The cool coins can be transferred to other members, etc. as described above.

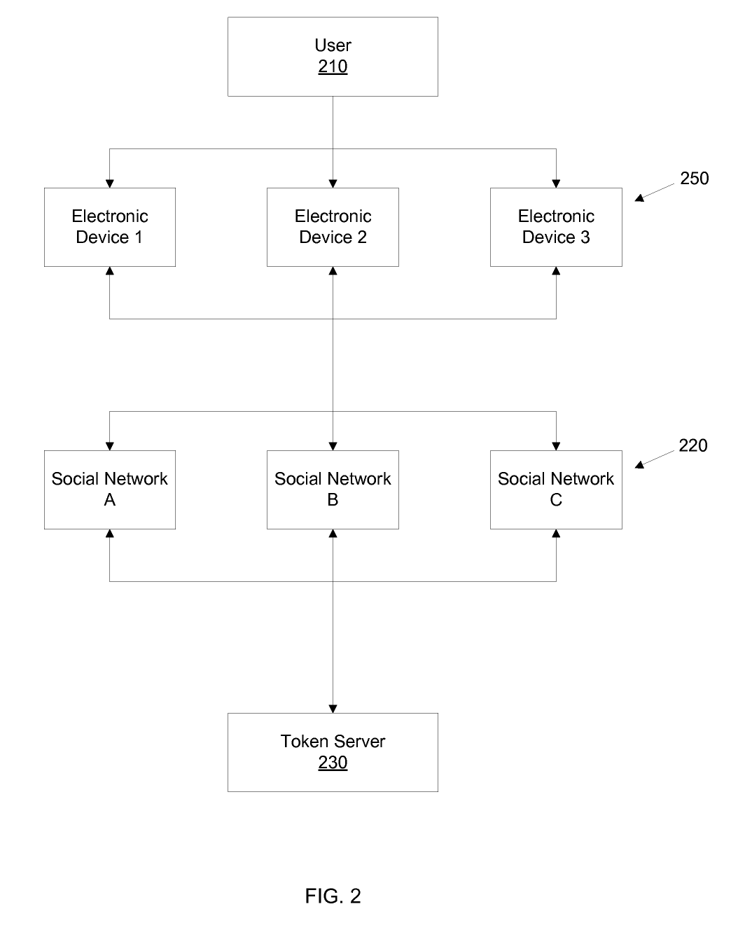

As shown in FIG. 2, a user 210 (also referred to as member) can access a token server 230 from one or more electronic devices 250 (e.g., a computer, cell phone, PDA, etc.) via a communications network, such as the Internet (not shown in FIG. 2). In other words, the user's account is not tied to a particular electronic device, but rather to the particular user profile. As shown in FIG. 2, the user can also access the system through multiple different social network web pages. For example, as described previously, the user can create an account with the token server directly, or through his/her association or membership with a social network. The user can also associate his/her user profile or account with multiple social networks 220 for which he/she is a member. Thus, the user can access the token server 230 via different social networks using the same account/user profile.

When accessing the system, the user will be presented with a log-in page that requires the user to enter the user's name and password (e.g., that can be set up during initial membership creation). The user name and password can be authenticated using, for example, OpenID known in the art. After being authenticated and logged-in to the system, the user can have access to his user profile and other account information. For example, the user can view and edit his profile, can view a balance of the number of cool coins in his account, the number of cool-coins received by other members or third parties, the number of cool coins transferred from the user to other members, the number of cool coins available to the user to give or transfer to others, the top users (e.g., top ten users) with the most cool coins, the top users (e.g., the top ten users) with the most coins within a category of interest to the user, the standing of the user in the top lists, promotions arranged by sponsors, awards given to users, a history of cool coin transfers and other actions taken by the user's friends, for example, in a particular social network. In some embodiments, information related to the transfer and receipt of coins by other members can be made available to the user.

In some embodiments, the user can be provided with a list of his friends from various social networks that are also members of the service and view various information related to his friends. The user can also search for friends in one or more social network, and invite or nominate friends to be become members of the token service.

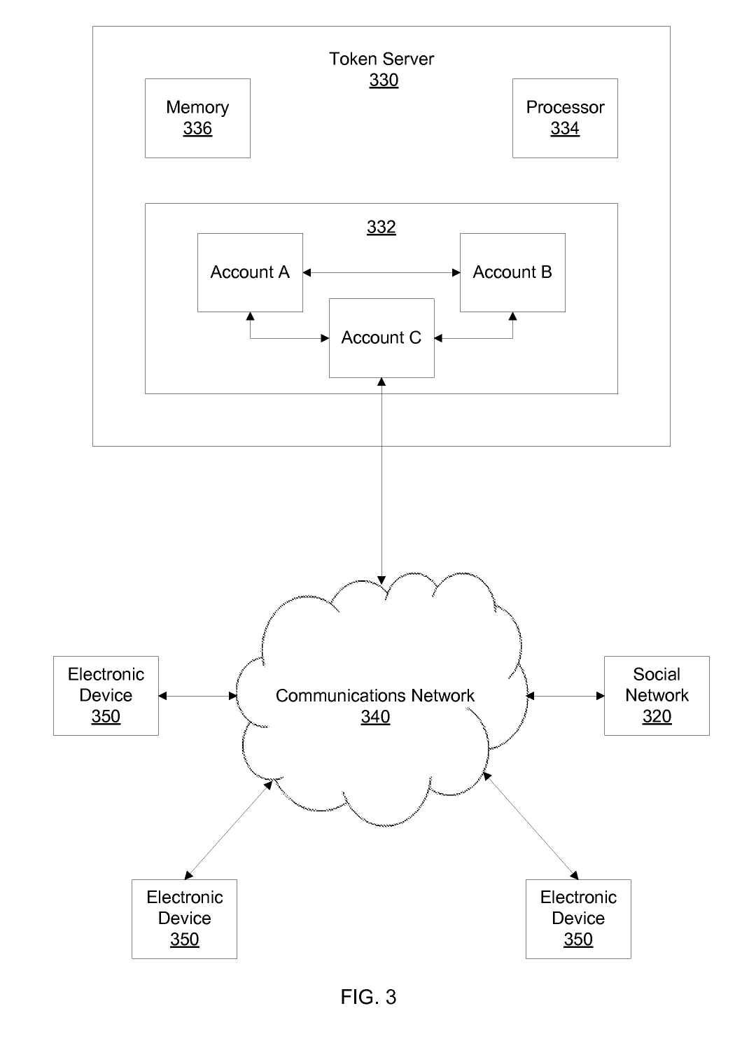

As described above, the user can request the transfer of cool coins to other users, receive cool coins from other users, and request that a previously given cool coin is revoked from a user. As shown in FIG. 3, a token server 330 can be in communication with one or more electronic devices 350 and to one or more social network websites (e.g., web servers) 320 via a network 340, such as the Internet. The token server 330 can include a database 332, one or more processors 334 and a memory component 336. The token server 330 can track the distribution and transfer of cool coins between members of the system. As shown in FIG. 3, the token server 330 can maintain an account associated with each member (e.g., members A, B, C, etc.). Within each account, the token server 330 can keep a balance of the number of cool coins (e.g., tokens) in a user's account and effectuate the transfer of cool coins between different accounts based on a request of a user. For example, the token server 330 can receive a request from user A to transfer a cool coin from user A's account to user B's account.

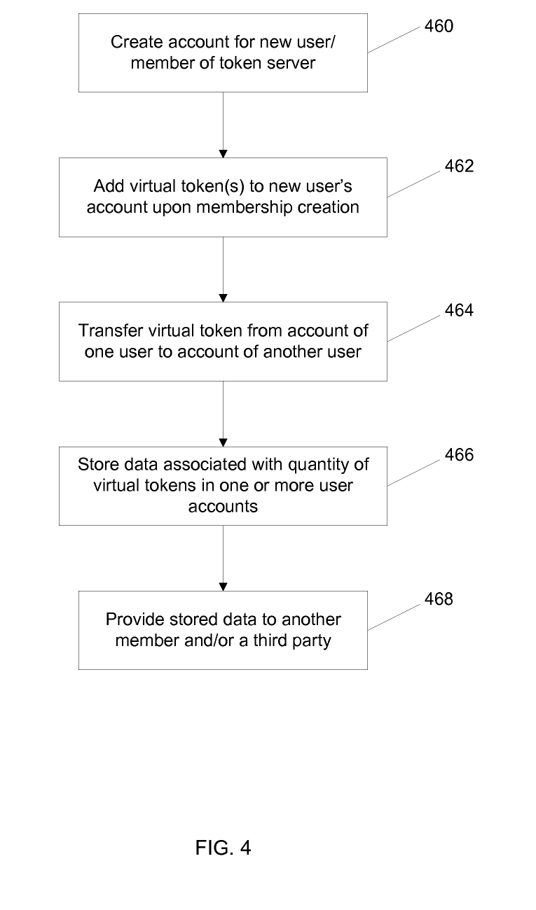

FIG. 4 is a flowchart illustrating a method according to an embodiment. The method includes at 460, creating an account for a new user of the token server. For example, the token server can receive a request for membership from a user via an electronic device. For example, the user can access the token server through a social network webpage for which the user is a member, or can access the token server directly. In some embodiments, an account for a user can be created via the user's association with a social network. In some embodiments, the token server can receive a request for nomination for membership of a user. For example, a current user or member can nominate or otherwise invite another user to become a member of the token server. At 462, at least one virtual token is added to an account associated with a user of a token server upon initial association (e.g., membership creation) of the user with the token server. For example, a predetermine finite quantity of tokens can be added to the account of the user upon creation of a membership with the token server as described herein. A virtual token can have an associated value that is different than another virtual token. A virtual token can also include identifying information and be capable of being tracked by the token server as the token is transferred between accounts.

The token server can be configured to transfer virtual tokens to and from accounts associated with multiple users or members and can be accessible by one or more electronic devices in communication with the token server via a network. At 464, at least one virtual token is transferred from an account associated with a first user of the token server to an account associated with a second user of the token server based upon a request received from the first user of the token server via an electronic device. For example, the transferred virtual token can be associated with a popularity rating of the second user. The token server can also receive requests from a user to revoke a transferred token back and add that revoked token back to that user's account. At 466, the token server can store data associated with a quantity of virtual tokens associated with one or more users of the token server. The token server can also store data related to the transfer activity between accounts. The stored data can be provided to one or more users of the token server or a third party at 468.

As described herein, the token server can also be configured to identify a user of the token server as influential based on one or more of a variety of different factors, such as, for example, (1) a quantity of virtual tokens associated with an account of the user, and/or (2) the rate of receipt of a predetermined quantity of virtual tokens associated with the user, and/or (3) a geographic location of the user. The token server can also add tokens to an account of a user for various other events such as, for example, based on an activity associated with the user of the token server.

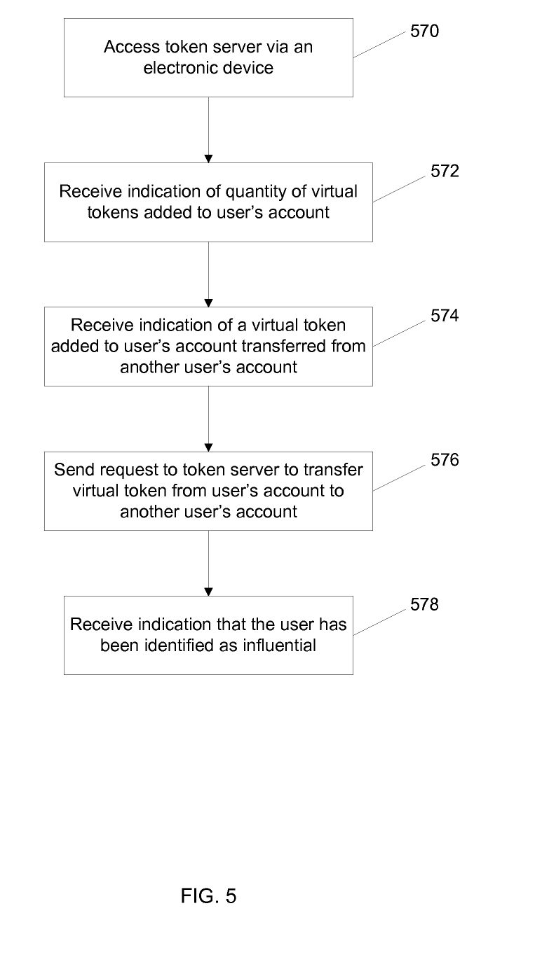

FIG. 5 is a flow chart illustrating another method according to an embodiment. The method includes at 570, a first user accessing a token server using an electronic device. For example, the first user can access the token server directly or via a social network website. At 572, an indication of a first quantity of virtual tokens associated with an account of a first user of the token server is received. For example, the first quantity of virtual tokens can be a predetermined finite quantity of virtual tokens available for distribution by the first user. At 574 an indication that at least one virtual token has been transferred from an account associated with a second user of the token server to the account associated with the first user of the token server is received. For example, a second user of the token server can request that a virtual token be transferred from his account to the account of the first user as an indication that the second user views the first user as being cool or popular. At 576, a request can be sent to the token server to request that at least one virtual token from the account associated with the first user of the token server be transferred to an account associated with another user of a third party. At 578, an indication that the first user is identified as influential is received. For example, the first user can be identified as influential based on a variety of factors, including, for example, (1) a quantity of virtual tokens associated with the account of the first user, and/or (2) the rate of receipt of a predetermined quantity of virtual tokens associated with the first user, and/or (3) a geographic location of the first user.

It is intended that the methods and services described herein can be performed by software, hardware, or a combination thereof. Hardware modules may include, for example, a general-purpose processor, a field programmable gate array (FPGA), and/or an application specific integrated circuit (ASIC). Software modules can be expressed in a variety of software languages (e.g., computer code), including C, C++, Java™, Ruby, Visual Basic™, and other object-oriented, procedural, or other programming language and development tools. Examples of computer code include, but are not limited to, micro-code or micro-instructions, machine instructions, such as produced by a compiler, and files containing higher-level instructions that are executed by a computer using an interpreter. Additional examples of computer code include, but are not limited to, control signals, encrypted code, and compressed code. Although a few embodiments have been shown and described, it will be appreciated that various changes and modifications might be made.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as application-specific integrated circuits (ASICs), Programmable Logic Devices (PLDs), and Read-Only Memory (ROM) and Random-Access Memory (RAM) devices.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. Furthermore, each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method, comprising:
adding to an account associated with a user of a token server upon initial association of the user with the token server, at least one virtual token, the token server being configured to transfer virtual tokens to and from accounts associated with a plurality of users, the token server being accessible by one or more electronic devices in communication with the token server via a network; and
transferring at least one virtual token from an account associated with a first user of the token server to an account associated with a second user of the token server based upon a request received from the first user of the token server via an electronic device.

2. The method of claim 1, further comprising:
storing data associated with a quantity of virtual tokens associated with one or more users of the token server.

3. The method of claim 1, further comprising:
storing data associated with a quantity of virtual tokens associated with one or more users of the token server; and
providing the data to at least one of a user of the token server or a third party.

4. The method of claim 1, wherein the transferred virtual token is associated with a popularity rating of the second user.

5. The method of claim 1, wherein the at least one virtual token added upon initial association of the first user with the token server is a predetermined finite quantity of virtual tokens.

6. The method of claim 1, further comprising:
prior to the adding, receiving at the token server a request for membership from the first user via an electronic device.

7. The method of claim 1, further comprising:
prior to the adding, receiving at the token server a request for membership from the first user via a social network website, the social network website being in communication with the token server via the network, the first user being a member of the social network website.

8. The method of claim 1, further comprising:
prior to the adding, receiving at the token server a request for nomination for membership of the first user with the token server from at least one of a second user of the token server or a third user of the token server via an electronic device in communication with the token server via the network.

9. The method of claim 1, further comprising:
after the transferring from an account associated with the first user to an account associated with a second user, transferring the transferred token back to the account associated with the first user.

10. The method of claim 1, further comprising:
identifying a user of the token server from the plurality of users of the token server as influential based on at least one of (1) a quantity of virtual tokens associated with an account of the user, or (2) the rate of receipt of a predetermined quantity of virtual tokens associated with the user, or (3) a geographic location of the user.

11. The method of claim 1, further comprising:
identifying a user of the token server from the plurality of users of the token server as influential based on a quantity of virtual tokens associated with an account of the user; and
sending a notification to at least another user of the token server from the plurality of users of the token server identifying the user as influential.

12. The method of claim 1, further comprising:
adding to an account associated with a user of the token server at least one virtual token based on an activity associated with the user of the token server.

13. The method of claim 1, further comprising:
adding to at least one account associated with a user of the token server a first virtual token having a first value and adding to at least one account associated with a user of the token server a second virtual token having a second value different than the first value.

14. A processor-readable medium storing code representing instructions to cause a processor to perform a process, the code comprising code to:
add to an account associated with a user of a token server upon initial association of the user with the token server, at least one virtual token, the token server being configured to transfer virtual tokens to and from accounts associated with a plurality of users, the token server being accessible by one or more electronic devices in communication with the token server via a network; and
transfer at least one virtual token from an account associated with a first user of the token server to an account associated with a second user of the token server based upon a request received from the first user of the token server via an electronic device.

15. The computer-readable medium of claim 14, further comprising code to:
store data associated with a quantity of virtual tokens associated with one or more users of the token server.

16. The computer-readable medium of claim 14, further comprising code to:
store data associated with a quantity of virtual tokens associated with one or more users of the token server; and
provide the data to at least one of a user of the token server or a third party.

17. The computer-readable medium of claim 14, wherein the transferred virtual token is associated with a popularity rating of the second user.

18. The computer-readable medium of claim 14, wherein the at least one virtual token added upon initial association of the first user with the token server is a predetermined finite quantity of virtual tokens.

19. The computer-readable medium of claim 14, further comprising code to:
prior to the adding, receive at the token server a request for membership from the first user via an electronic device.

20. The computer-readable medium of claim 14, further comprising code to:
prior to the adding, receive at the token server a request for membership from the first user via a social network website, the social network website being in communication with the token server via the network, the first user being a member of the social network website.

21. The computer-readable medium of claim 14, further comprising code to:
prior to the adding, receive at the token server a request for nomination for membership of the first user with the token server from at least one of a second user of the token server or a third user of the token server via an electronic device in communication with the token server via the network.

22. The computer-readable medium of claim 14, further comprising code to:
after the transferring from an account associated with the first user to an account associated with a second user, transfer the transferred token back to the account associated with the first user.

23. The computer-readable medium of claim 14, further comprising code to:
identify a user of the token server from the plurality of users of the token server as influential based on at least one of (1) a quantity of virtual tokens associated with an account of the user, or (2) the rate of receipt of a predetermined quantity of virtual tokens associated with the user, or (3) a geographic location of the user.

24. The computer-readable medium of claim 14, further comprising code to:
identify a user of the token server from the plurality of users of the token server as influential based on a quantity of virtual tokens associated with an account of the user; and
send a notification to at least another user of the token server from the plurality of users of the token server identifying the user as influential.

25. The computer-readable medium of claim 14, further comprising code to:
add to an account associated with a user of the token server at least one virtual token based on an activity associated with the user of the token server.

26. The computer-readable medium of claim 14, further comprising code to:
add to at least one account associated with a user of the token server a first virtual token having a first value and add to at least one account associated with a user of the token server a second virtual token having a second value different than the first value.

27. A computer implemented method, comprising:
receiving an indication of a first quantity of virtual tokens associated with an account of a first user of a token server, the token server being accessible by the first user via an electronic device; and
receiving an indication that at least one virtual token has been transferred from an account associated with a second user of the token server to the account associated with the first user of the token server.

28. The computer implemented method of claim 27, wherein the at least one virtual token received from the second user of the token server is an indication of the popularity of the first user of the token server.

29. The computer implemented method of claim 27, further comprising:
sending a request to the token server to transfer at least one virtual token from the account associated with the first user of the token server to at least one of the account associated with one of the second user of the token server or a third user of the token server.

30. The computer implemented method of claim 27, wherein the first quantity of virtual tokens is a predetermined finite quantity of virtual tokens:

31. The computer implemented method of claim 27, further comprising:
accessing the token server from an electronic device via a social network website.

32. The computer implemented method of claim 27, further comprising:
accessing the token server from an electronic device via a social network website, the first user of the token server and the second user of the token server being members of the social network website.

33. The computer implemented method of claim 27, further comprising:
accessing the account of the first user of the token server via an electronic device in communication with the token server via the network; and
receiving from the token server an indication that the first user is identified as influential based on at least one of (1) a quantity of virtual tokens associated with the account of the first user, or (2) the rate of receipt of a predetermined quantity of virtual tokens associated with the first user, or (3) a geographic location of the first user.

34. A method, comprising:
creating at a token server an account associated with a first user of the token server, the first user accessing the token server via a social network website in communication with the token server via a network;
adding to the account associated with the first user of the token server upon initial association of the first user with the token server, at least one virtual token, the token server being configured to transfer virtual tokens to and from accounts associated with a plurality of users of the token server, the token server being accessible by one or more electronic devices in communication with the token server via a network; and
transferring at least one virtual token from the account associated with the first user of the token server to an account associated with a second user of the token server based upon a request received from the first user of the token server via the social network website, the second user of the token server being accessible by the token server via the social network website.

35. The method of claim 34, wherein the transferred virtual token is associated with a popularity rating of the second user.

36. The method of claim 34, further comprising:
providing an accounting of the quantity of virtual tokens associated with one or more users associated with the token server.

37. The method of claim 34, wherein the at least one virtual token added upon initial association of the first user with the token server is a predetermined finite quantity of virtual tokens.

38. The method of claim 34, further comprising:
after the transferring from an account associated with the first user to an account associated with a second user, transferring the transferred token back to the account associated with the first user.

39. The method of claim 34, further comprising:
after the transferring from an account associated with the first user to an account associated with a second user, transferring the transferred token back to an account associated with a third user of the token server.

40. The method of claim 34, further comprising:
identifying a user of the token server from the plurality of users of the token server as influential based on at least one of (1) a quantity of virtual tokens associated with an account of the user, or (2) the rate of receipt of a predetermined quantity of virtual tokens associated with the user, or (3) a geographic location of the user.

41. The method of claim 34, further comprising:
sending a notification to at least one user of the token server from the plurality of users of the token server identifying another user of the token server as influential.

42. The method of claim 34, further comprising:
adding to an account associated with a user of the token server at least one virtual token based on an activity associated with the user of the token server.

43. The method of claim 34, further comprising:
adding to at least one account associated with a user of the token server a first virtual token having a first value and adding to at least one account associated with a user of the token server a second virtual token having a second value different than the first value.
